(19) United States
(12) Patent Application Publication
(10) Pub. No.: US 2006/0226202 A1
(43) Pub. Date: Oct. 12, 2006

(54) PCB solder masking process

(76) Inventor: Ho-Ching Yang, Ping Chen City (TW)

Correspondence Address: LEONG C LEI, PMB # 1008, 1867 YGNACIO VALLEY ROAD, WALNUT CREEK, CA, 94598, US

(21) Appl. No.: 11/102,659

(22) Filed: Apr. 11, 2005

(51) Int. Cl. B23K 31/00

(52) U.S. Cl. 228/214

(57) ABSTRACT

A PCB solder masking process allowing easier process, reduced production cost and improved PCB quality involves dispensing low hardness resin on contacts to be exposed on the PCB, resin being solidified, non-solidified area covered with mask, UV exposed, non-solidified area removed, PCB sprayed insulation varnish, solidified, varnish and resin on surface of contact removed, either sanded or sandblasted, and finally cleaned and rinsed.

### BACKGROUND OF THE INVENTION

(a) Technical Field of the Invention

The present invention is related to a PBC solder masking process, and more particularly, to one that is simple, low-cost, and capable of correcting variation in electric characteristics due to poor dispensing of solder masking material found in the prior art.

(b) Description of the Prior Art

Whereas the PCB solder masking process is usually done by having exposed the negative of the circuitry and made it into a screen, then ink printed to coat the screen on the area where exposed out of the contacts, the process is found with the following flaws:
1. Higher production cost since more consumption items and longer process time are required;
2. PCB electric characteristics are affected by variation in resistance due to inconsistent thickness of the ink dispensed;
3. Increased investment and production costs in the comparatively advanced facilities to achieve the purpose of consistently dispensed ink;
4. More facilities and longer process are required because that the conventional process relates to image transfer technology; and
5. Significant variation in dimension resulted from the relative humidity to discourage production reliability, as the negative used is highly sensitive to the ambient temperature.

Furthermore, the color of the solder masking structure appears to be monotonous, lacking in change, and vulnerable to scratch.

### SUMMARY OF THE INVENTION

The primary purpose of the present invention is to provide a PCB solder masking process that corrects the flaws found with the process of the prior art, and allows lower production cost and higher PCB quality.

To achieve the purpose, a steel plate drilled with holes at where the exposure is desired is used to dispense those contacts to be exposed from the PCB with a lower hardness resin, and then the resin is exposed to UV radiation to get solidified. An insulation varnish is sprayed on the PCB and the varnish sprayed is thinner than that of the resin dispensed. Leave the varnish to get solidified. The varnish on the surface of the resin, and the resin are removed by either sanding or sandblasting to expose those contacts while the other area of the PCB remains covered by the varnish. Upon the completion of the varnish spray on the PCB, the area other than those contacts may be printed with a pattern and/or letters while directly serving as the casing of the product.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart of the process of the present invention.

FIG. 2 is a schematic view showing a structure of a PCB used in the present invention.

FIG. 3 is a schematic view showing that a resin is dispensed in the process of the present invention.

FIG. 4 is a schematic view showing that an insulation varnish is sprayed on the PCB in the process of the present invention.

FIG. 5 is a schematic view showing a structure of the PCB completed with the solder masking process in the present invention.

FIG. 6 is a perspective view showing the PCB completed with the solder masking process in the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

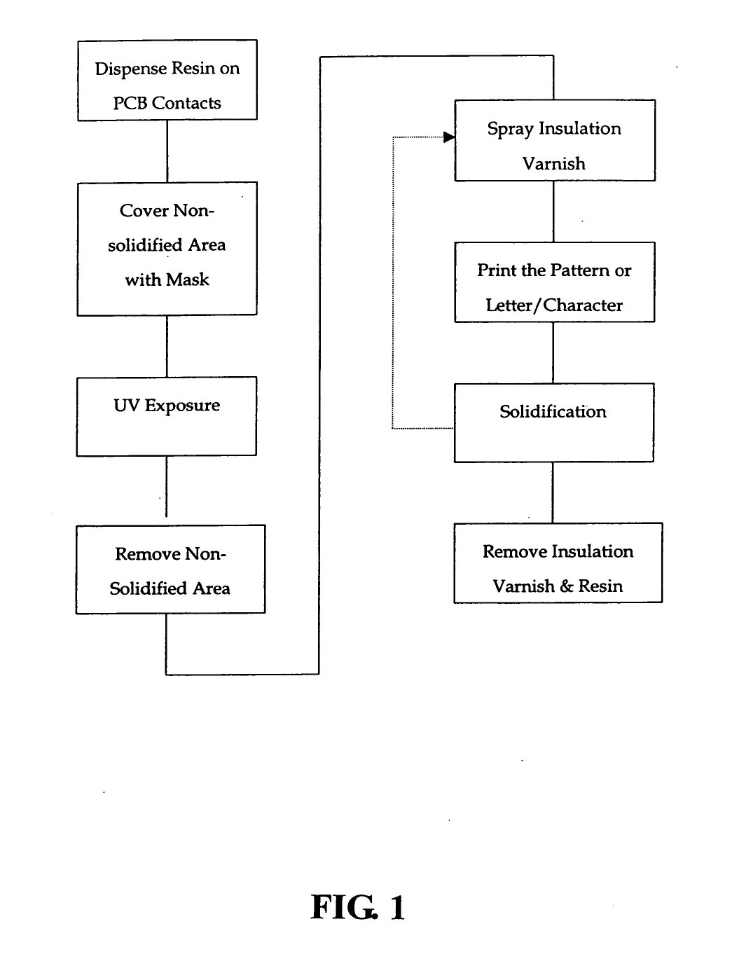

Referring to FIGS. 1 through 5, the solder masking process of the present invention is essentially comprised of the following steps:

Step 1: a steel plate is produced by following a pattern as demanded and drilled with multiple holes at where a plurality of contacts 21 to be exposed from a PCB 2 and the diameter of each hole must be greater than that of the contact 21; each hole is dispensed with a resin 1 of a low hardness though the steel plate to such extent that the dispensed area must be greater than that of the contact 21 and fully mask the contact 21.

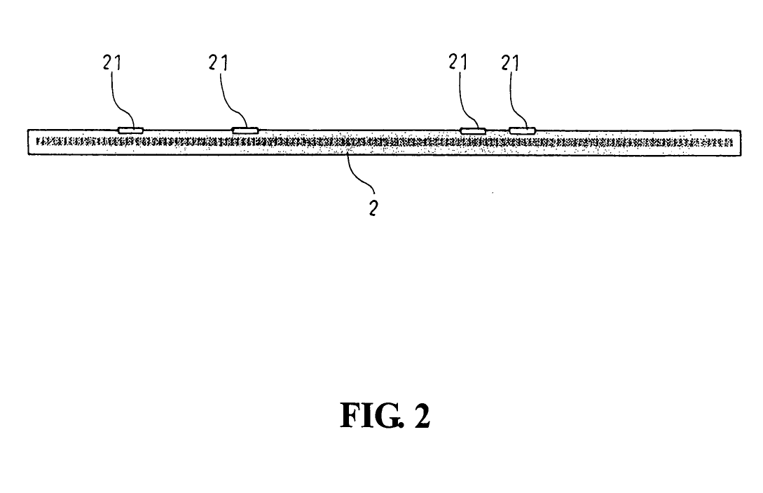

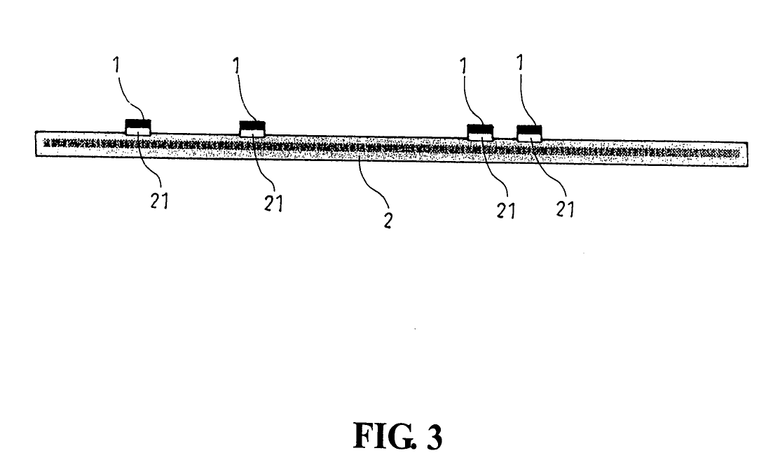

Step 2: Prepare another steel plate also drilled with multiple holes at where those contacts dispensed with resin are located, place the steel plate on top of the PCB 2 already dispensed with the resin 1 and then expose the PCB 2 in UV radiation for the resin 1 confined by the holes to get solidified as illustrated in FIGS. 2 and 3.

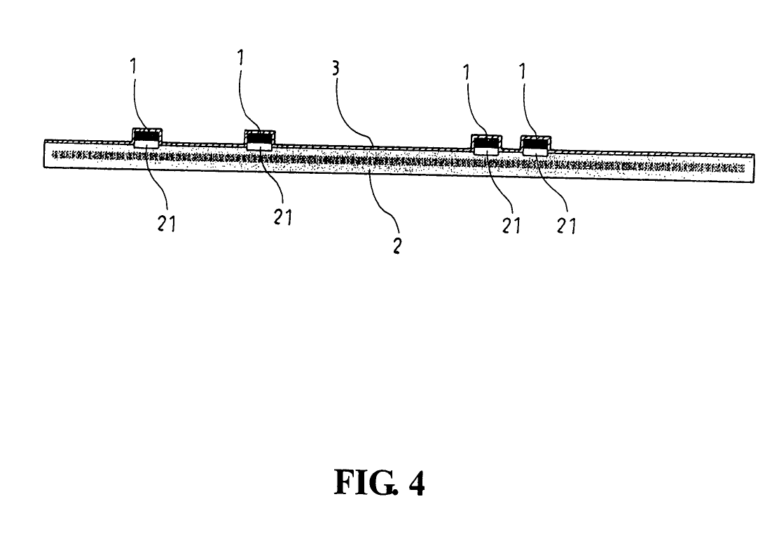

Step 3: With the steel plate removed, spray to coat an insulation varnish 3 on the PCB 2. Wherein, the insulation varnish 3 coated must be thinner than the resin 1 dispensed. The PCB 2 is again exposed to UV radiation for the varnish 3 to get solidified as illustrated in FIG. 4.

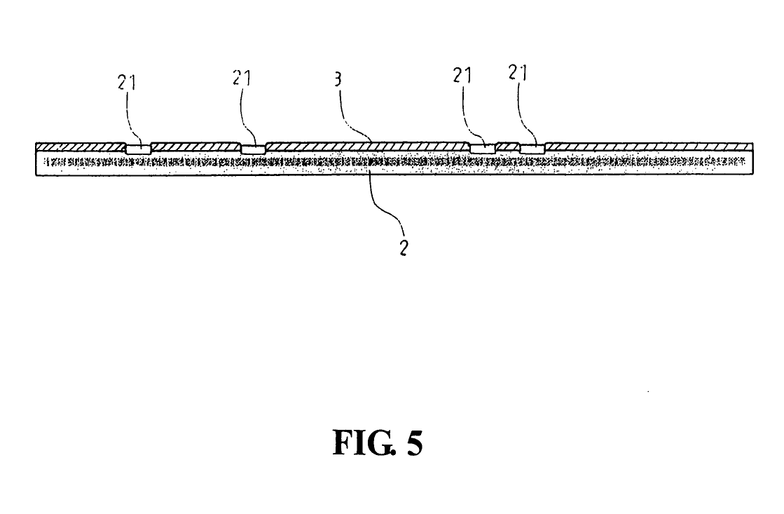

Step 4: Both of the insulation varnish 3 and the resin 1 solidified on top of each contact 21 are removed either sanded or sandblasted as illustrated in FIG. 5. The PCB 2 is then cleaned and rinsed to leave all contacts 21 exposed while the remaining area on the PCB 2 are still covered by the insulation varnish 3.

Step 5: As required, a second course of varnish 3 may be sprayed on the PCB 2 to increase the thickness of the varnish on the PCB 2 to facilitate the direct use as a casing.

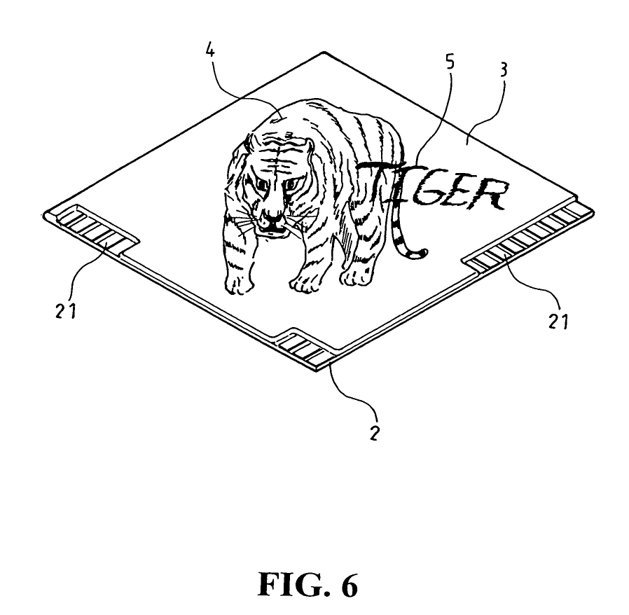

With the solder masking process of the present invention, the PCB 2 reserves only those contacts 21 that exposure is required while the remaining area of the PCB 2 are covered up by the insulation varnish 3 as illustrated in FIG. 6. Accordingly, the area covered by the insulation varnish 3 permits may be made in any color as desired; or alternatively, a pattern 4 or a brand/trade name 5 may be printed on where covered by the varnish at the same time when the varnish is sprayed. Furthermore, the PCB 2 itself may directly serve as a casing. Meanwhile, the solder masking structure constituted by the insulation varnish 3 offers the following advantages:
1. The hardness and adherence of the material used in the process of the present invention are far better than the ink used in the prior art, thus to significantly improve PCB impact durability including thermal impact and chemical impact.
2. The thickness of the insulation varnish sprayed is consistent to prevent the undesired changed in electric characteristics of the PCB as found with the solder masking process of the prior art due to the inconsistently dispensed ink.
3. Less consumption items are required to significantly reduce the production cost.
4. Steel plate is used to produce the pattern so to avoid potential variation of the dimension of the pattern due to changes in ambient temperature and relative humidity.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A PCB solder masking process includes the following steps:
A steel plate is produced by following a pattern as demanded, and multiple holes are drilled at where a plurality of contacts on the PCB to be exposed.
Cover the PCB with the steel plate and dispense a resin of lower hardness on those contacts to such extent to fully cover up them.
Another steel plate is produced and drilled thereon with multiple holes with each in the dimension as specified in the pattern for the plurality of contacts to be exposed; then place the steel plate on top of the PCB already dispensed with the resin to be exposed to UV radiation for the resin in the hole of the plate to get solidified.
Coat by spray an insulation varnish on the PCB and leave the insulation varnish to get solidified.
Both of the insulation varnish and resin deposited on each contact are removed, either sanded or sandblasted.
After cleaning and rinsing the PCB to expose those contacts while the remaining area of the PCB is covered up by the insulation varnish.

2. The PCB solder masking process of claim 1, wherein the resin and the insulation varnish are baked in an oven to get solidified.

3. The PCB solder masking process of claim 1, wherein the insulation varnish sprayed is thinner than the resin dispensed on those contacts to be exposed.

4. The PCB solder masking process of claim 1, wherein the insulation varnish covering up the PCB is in any color as desired.

5. The PCB solder masking process of claim 1, wherein the insulation varnish covering the PCB is printed with a pattern or letters at the same time the insulation varnish is sprayed

6. The PCB solder masking process of claim 1, wherein both the process to remove the insulation varnish and the resin deposited on the surface of each contact is done by using the sanding and the sandblasting methods.
